(19) United States
(12) Patent Application Publication
(10) Pub. No.: US 2015/0233612 A1
(43) Pub. Date: Aug. 20, 2015

(54) RECYCLING THERMAL SOURCES

(71) Applicants: Scott M. Zimmerman, Basking Ridge, NJ (US); William R. Livesay, San Diego, CA (US)

(72) Inventors: Scott M. Zimmerman, Basking Ridge, NJ (US); William R. Livesay, San Diego, CA (US)

(73) Assignee: e-Beam & Light, Inc., San Diego, CA (US)

(21) Appl. No.: 14/702,719

(22) Filed: May 2, 2015

Related U.S. Application Data
(63) Continuation of application No. 12/804,475, filed on Jul. 21, 2010.

(51) Int. Cl. F25B 21/02; H05B 3/00

(52) U.S. Cl. CPC F25B 21/02; H05B 3/009

(57) ABSTRACT

The invention is a thermal recycling system for converting lower quality thermal sources into higher quality thermal sources. In one embodiment, at least one photonic crystal radiator is combined with at least one substantially different radiator within a low loss thermal recycling cavity. Thermal recycling is based on the use of spectrum, polarization and temporal restrictions. These systems can be used in cooling, heating, and energy production.

### CROSS-REFERENCE TO RELATED APPLICATIONS

This application is a Continuation of U.S. patent application Ser. No. 12/804,475, filed on Jul. 17, 2010, which is incorporated by reference.

This application claims the benefit of U.S. Provisional Patent Application Ser. No. 61/271,503, filed on Jul. 20, 2009, which is herein incorporated by reference

### TECHNICAL FIELD

The present invention is a recycling thermal source which incorporates a restriction of at least one of following properties of actinic radiation: spectrum, polarization, or temporal nature.

### BACKGROUND OF THE INVENTION

Recycling systems have been demonstrated for a variety of optical systems. Localized areas of higher photon flux are generated in these systems. Optical systems enhance brightness and power density using recycling optical cavities. In this case, non-blackbody radiators such as LEDs, phosphors, and fluorescent lamps are used within highly reflective cavities. If these sources exhibit sufficient reflectivity to the photons they emit, it is possible to generate enhanced radiance within the cavity and/or at the output aperture of the cavity relative to the source radiance these sources emit outside the recycling cavity. Enhancements of over 15× have been demonstrated in highly reflective systems such as phosphor based sources. These sources operate outside the basic assumptions and boundary conditions of equilibrium and blackbody radiators used to form conservation of optical extent theory and Kirchhoff's Law.

Numerous articles and papers have been written over the last 150 years pointing out experimental and theoretical sources which do not obey Kirchhoff's Law, especially sources which are non-blackbody radiators (Kirchhoff's Law of Thermal Emission: 150 Years, Pierre-Marie Robitaille, Progress in Physics October 2009, volume 4). Kraabel (On the validity of Kirchhoff's law, B. Kraabel, M. Shiffmann, P. Gravisse, Laboratoire de Physique et du Rayonnement de la Lumière) as well as others have demonstrated numerous situations, in which Kirchhoff's law cannot be used effectively, such as paints with metallic particles, layered optical materials, or semi-infinite bodies with a large thermal gradient at the surface. In general, the basic concept that cavities are always black regardless of the properties of the materials from which they are constructed has been proven invalid and the formation of blackbody cavities which even approach blackbody radiators requires specialized materials and form factors. A wide range of recycling products enhance brightness, radiance, and energy/power density which clearly operate outside present day understanding of Kirchhoff's Law and the conservation of optical extent theory. While, alternate interpretations can be used to try and overcome these deficiencies, the reality is that a great deal of confusion and misuse of these theories has resulted. It is reasonable to state that both these theories are only strictly valid for blackbody radiators at thermal equilibrium. It is also reasonable to state that the improper use of these theories has been used to set limits which can be overcome in the case of sources and optical systems which deviate significantly from blackbody behavior. As such an alternate theory based on Heisenberg's uncertainty principle has been developed.

This new theory requires only that there be a change in the uncertainty of at least one property of a photon or assemblage of photons (momentum, polarization, wavelength, position, etc.) within a given system to allow for localization of energy density within the system. This theory accurately predicts the effects measured in recycling optical cavities presently being created by Goldeneye, Inc. The use of Heisenberg uncertainty principles are already used in commercial ray tracing algorithms to accurately predict wave based effects such as edge diffraction from companies such as Lambda Research (Edge Diffraction in Monte Carlo ray tracing, Feniere, Gregory, Hasler, Optical Design and Analysis Software, Proceedings of SPIE, Volume 3780, Denver, 1999.). In this case Heisenberg's Uncertainty principle is used to modify the direction of each ray based on its position as it passes in proximity to an edge. Heisenberg states that if there is a decrease in the uncertainty in position there will be a corresponding increase in momentum. In the Lambda Research's ray tracing software, the distance of each ray from the edge is used to modify the momentum of the ray by bending the ray towards the edge. The algorithm accurately predicts the diffraction of light at an edge, which is clearly a wave based mechanism. This application proposes that Heisenberg's Uncertainty principles can be used to overcome the deficiencies found in Kirchhoff's Law and the theory of optical extent. Because uncertainty relationships exist between all the properties of actinic radiation, this alternate theory has broad applicability. In addition Heisenberg's Uncertainty Principles represent the ultimate limits for actinic radiation so their use as performance boundaries for optical systems is appropriate.

One type of recycling optical cavity based on this theory is constructed using highly reflective LEDs in which the area of emission is greater than the exit aperture of the cavity. Based on the reflectivity of the LEDs and cavity and the area relationship of the emitter area and the output aperture area, it is easy to calculate the brightness/radiance gain of the cavity relative to a LED external to the cavity. It is also very easy to model this optical system using standard ray tracing techniques. If the optical path length of the rays exiting through the aperture of the cavity is tabulated and a histogram of optical path length is created, it can be shown that the brightness/radiance enhancement of the recycling optical cavity (gain) at the output aperture exactly corresponds to the average increase in optical path length. Optical path length can then be correlated to the temporal distribution of the optical rays passing through the aperture of the cavity. The corresponding Heisenberg relationship is ΔtΔE≧h. In other words, as the uncertainty of when a particular ray exits the aperture of this type of system is increased (e.g. rays spend time bounces around in the cavity), then an equivalent decrease in the uncertainty that energy is present at the aperture is allowed (e.g. more photons per unit area at the exit aperture of the cavity). This increase of energy density within the cavity and at the output aperture translates into higher watts per unit area at the aperture of the cavity than is being emitted by the emitting LEDs if they were just emitting external to cavity. This is a clear violation of the optical extent theory unless an additional term is added which takes into account the temporal effects discussed earlier. Interestingly, a temporal term already exists within the optical extent theory based on the effects of refractive index. The proposed new theory simply expands refractive index term to include other temporal effects created by recycling. In the extreme, if photons are being continuously emitted from a source in a cavity which do not absorb any of the photons emitted, eventually all those photons must exit the cavity or the conservation of energy law is violated. If the cavity output aperture is small relative to the emitting area within the cavity, the density of photons per unit area at the aperture must increase to a level determined solely by the area ratio of the emitting source and aperture.

In the case of recycling optical cavities based on LEDs, the emitting sources are highly reflective to the light they emit, while the aperture represents a perfect absorber. In addition, a wide range of materials including air can be used within the cavity which does not absorb the radiation emitted by the LEDs. The limited wavelength range of operation also further enables the effectiveness of this type of recycle optical cavity.

However, based on the proposed uncertainty theory, even low level thermal sources can also be enhanced. The requirements are the same (e.g. low absorption in the emission range and a recycling means), but the wavelength range is greatly expanded which limits the materials which can be used effectively and imposes the need for a low absorption means within the cavity (e.g. vacuum or equivalent) to reduce absorption losses from the air itself. It is proposed that these losses are the limiting factor to enhancing low level thermal sources and the reason there appears to be a fundamental restriction of creating high quality thermal sources from low quality thermal sources. Based on this new theory, a large area source exhibiting non-blackbody properties can be coupled to a smaller area with much different radiative properties and the smaller area can have a higher temperature than the large area source.

From a practical standpoint, several hurdles exist. The wavelength range of low level thermal radiators extends from microns down into the microwave region. No one material exists which exhibits low absorption over this wide wavelength range. KBr and other binary inorganics are transparent from the visible region down to 10s of microns, while organic polymers like CTFE exhibit low absorption losses from microwave up to 100s of microns. Not only does no single material exhibits low absorption throughout the entire wavelength range of thermal radiation, there also exists a gap of low absorption materials centered within the emission spectra of most thermal sources. In addition, water vapor and even the air can strongly absorb throughout this range of wavelengths. As such there is little wonder that the perception is that thermal sources cannot be enhanced.

Recently however, Sandia Labs has demonstrated that photonic bandgap structures can be constructed which restrict the spectral range of blackbody radiators. In their work, tungsten filaments were constructed to contain photonic bandgaps which could only radiate a specific range of wavelengths. Using these structures, researchers were able to create incandescent light sources which emitted more visible light because longer wavelengths were forbidden to emit by the photonic bandgap structure itself. As stated earlier, the criteria for localization of energy within an optical system based on the new theory is simply that there be two surfaces which exhibit significantly different radiative properties and that they be connects via a low loss optical system. This invention generally discloses methods by which two surfaces which differ substantially in their radiative characteristics can be coupled via a low loss optical means to enhance the energy density of surface relative to the other. More specifically, this invention relates to the use of photonic bandgap radiators in vacuum recycling thermal cavities. In this case, a large photonic bandgap surface would be coupled to a smaller absorptive surface. The radiative nature of the photonic bandgap would be significantly different than the smaller absorptive surface. The ability of the smaller absorptive surface to radiate energy back to photonic bandgap surface will be significantly hindered by the photonic bandgap itself. To reduce absorption losses within the system, a vacuum enclosure is a preferred embodiment of this invention. This eliminates gas and water vapor absorption losses. This disclosure covers apparatus and uses of recycling systems that localize the energy density within thermal systems down to and including ambient environment and below.

### SUMMARY OF THE INVENTION

This invention relates to the use of thermal recycling systems to enhance thermal sources. These systems do not violate the conservation of energy. They, however, do allow for the localization of regions of higher flux density than the source provides outside the recycling system. This localization can be used to create a temperature gradient within the recycling system. In this manner, a low quality thermal source can be enhanced into a higher quality thermal source. In general terms, thermal recycling systems allow for the conversion of low quality thermal sources into high quality thermal sources. Given that low quality thermal sources are everywhere, the ability to enhance these sources would enable distributed energy sources. The largest and most distributed energy source is the ambient environment. It is the summation of solar, geothermal, wind, fossil fuels, etc. This invention enables access to these low thermal quality sources via thermal recycling.

As the efficiency of lighting and electronic devices increases these thermal recycling systems can replace batteries in fixed and mobile applications. The use of thermoelectric means to directly convert the resulting temperature gradient in a thermal recycling system into electrical energy is a preferred embodiment of this invention. The use of this technique to convert body heat into useful energy for mobile applications is also disclosed. The use of this technique to enhance the efficiency of solar, power plants and other energy source is also disclosed.

### BRIEF DESCRIPTION OF THE DRAWINGS

FIG. 1 depicts a recycling optical cavity.

FIG. 2 depicts optical rays traced within the cavity.

FIG. 3 depicts a histogram of optical path length within the cavity.

FIG. 4 depicts absorption losses within the EM spectrum.

FIG. 5 depicts a photonic band gap emission spectrum.

FIG. 6 depicts a photonic band gap radiator surrounding a smaller absorptive radiator within a vacuum cavity of the present invention.

FIG. 7 depicts a recycling thermal source used to heat water of the present invention.

FIG. 8 depicts a recycling thermal source used to create electricity of the present invention.

FIG. 9 depicts a recycling thermal source used to recover waste heat of the present invention.

FIG. 10 depicts a compact recycling thermal source used to power portable devices of the present invention.

FIG. 11 depicts a recycling thermal source as a distributive power source of the present invention.

### DETAILED DESCRIPTION OF THE INVENTION

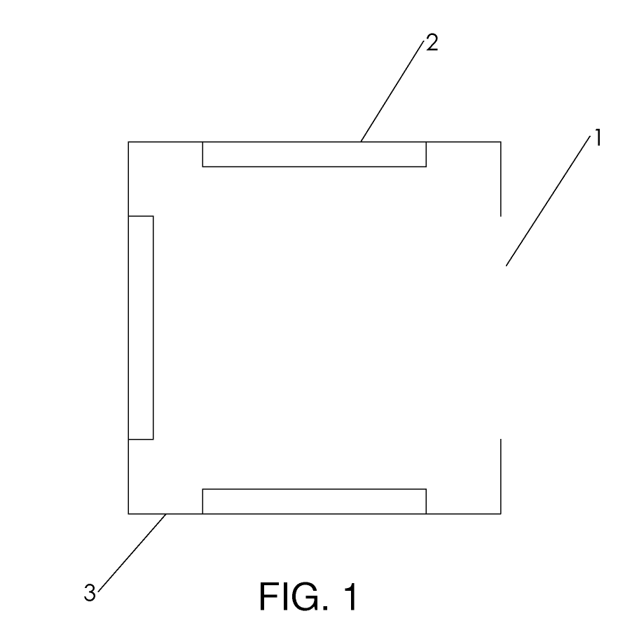

FIG. 1 depicts a recycling optical cavity containing reflective light emitting diodes 2 contained within a low absorption cavity 3 and an output aperture 1. If the emitting area of the light emitting diodes 2 is larger than the area of the output aperture 1 and the losses within the cavity are low enough, the watts per unit area at the output aperture 1 will be higher than the watts per unit area of the light emitting diodes 2 outside the cavity. This effect is presently used to enhance brightness for projection and other low etendue sources and is described in greater detail in U.S. Pat. Nos. 6,869,206 and 6,960,872, commonly assigned as the present application and herein incorporated by reference.

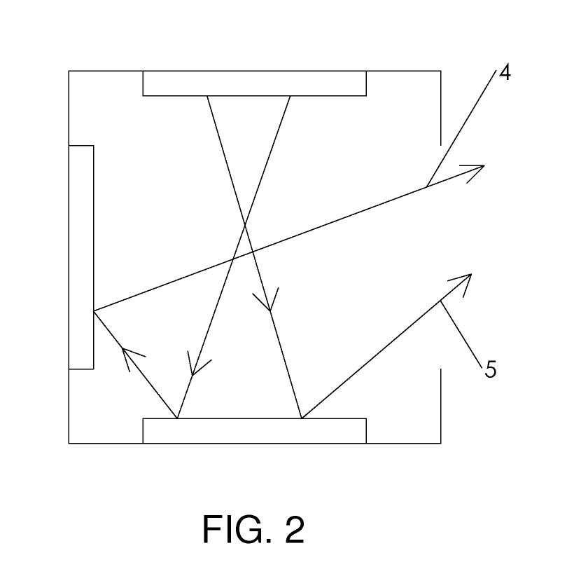

FIG. 2 depicts light rays 4 and 5 within the cavity. Ray tracing is used as an illustration tool to describe the basic principles of this invention. The validity of ray tracing to describe optical systems is well documented. In addition, Heisenberg uncertainty principles are already used in commercial ray tracing algorithms to accurately predict wave based effects such as edge diffraction from companies such as Lambda Research. The intent of the invention is to disclose recycling system which can be used to enhance low quality thermal systems based on the theory previously discussed.

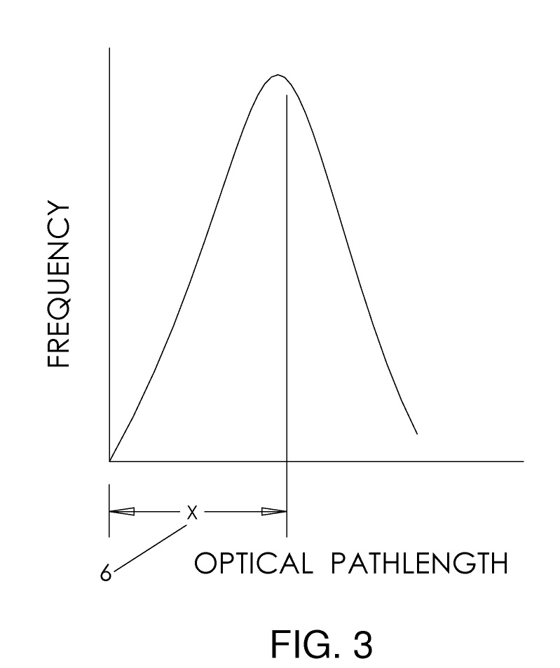

FIG. 3 depicts an optical path length histogram of rays within a recycling cavity. In an ideal cavity with no losses, the average optical length can be directly related to average optical path length 6 of this histogram. The optical path length is directly related to the time constant of the optical system. The use of recycling cavities to temporally broaden laser pulses is well documented and commercially available. By increasing the time constant of the optical system (e.g. increasing uncertainty of Δt), the energy density elsewhere within the optical system can be increased (e.g. decreased uncertainty of ΔE). This invention relates to creating thermal recycling systems which take advantage of these effects. In the case of optical recycling cavities containing reflective LEDs, broadening the average optical path length within the cavity enables the brightness/radiance of the output aperture to be increased by factors of 2 or more. By definition, the flux density in watts per unit area is also increased by factors of 2 or more relative to the emitting sources outside the recycling cavity. Fundamental to the success of this approach is elimination of losses within the cavity and at the sources. In the case of optical recycling cavities the sources exhibit very low absorption losses to the wavelengths of light emitted, while the aperture exhibits very high absorption to the wavelengths of light emitted. In addition the cavity itself and air within the cavity absorb very little of the light emitted. In order for this effect to be used with thermal sources, low loss recycling systems must be created.

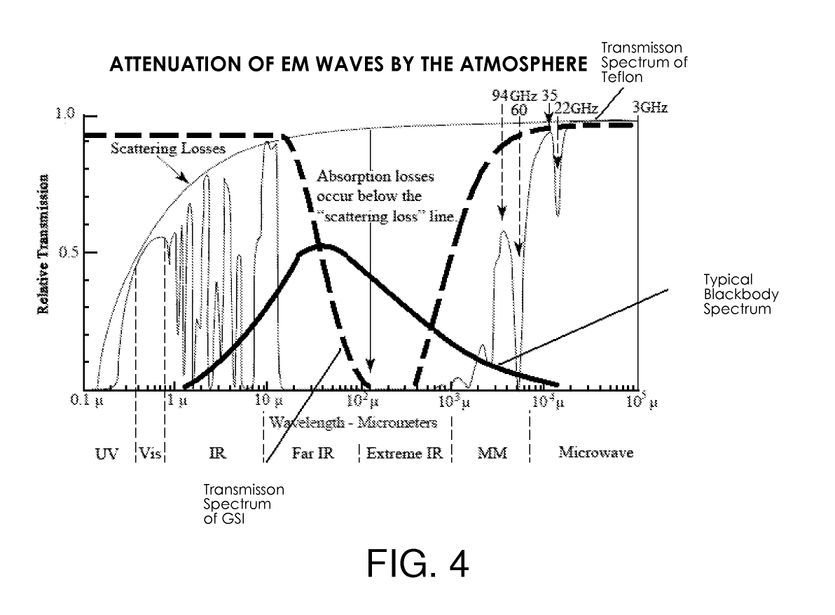

FIG. 4 depicts the various losses imposed by the ambient environment. Due to the broad nature of typical blackbody radiation, absorption losses are difficult to minimize in thermal recycling systems. Typically low quality thermal sources will radiate between 1 micron and 10000 microns of wavelength. The classic Planckian curve is illustrated in FIG. 4. It should be noted that, between 10 microns and 1000 microns, there is very strong absorption within our atmosphere. These absorption losses limit the efficiency of any recycling cavity. In addition, no one naturally occurring material exists which does not absorb over a significant portion of the wavelength range of a typical blackbody radiator. Also shown in FIG. 4 are the transmission spectrum of CsI which is transparent between 0.1 microns and 40 microns and Teflon which exhibits low absorption losses between 1000 microns and audio frequencies. In both cases, absorption loss within the region between 10s of microns and 1000 microns (which also coincides with the majority of the power emitted by a typical blackbody) becomes the determining factor in the efficiency of any recycling system. These absorption losses can be overcome using the techniques disclosed in this invention.

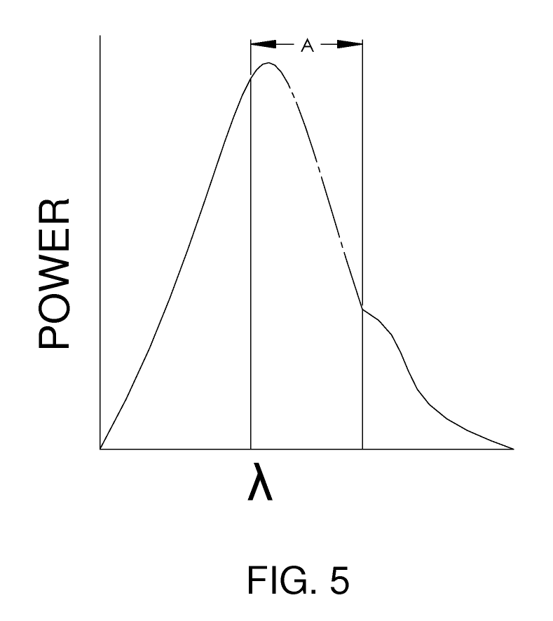

FIG. 5 depicts a blackbody radiation spectrum which has been modified through the use of a photonic bandgap structure. Blackbody thermal radiators emit over a wide spectral range, as stated earlier most materials absorb in a significant percentage of this spectral range, including air. As known in the art, photonic bandgap structures can be used to restrict the emission spectra of thermal sources. As shown in FIG. 5, excluded wavelengths 7 are not allowed based on the structure of the emitting surface. This effect was used to enhance the efficiency of emission in the visible spectrum for incandescent sources based on the work out of Sandia Labs. In this invention, restriction of the wavelength range permits the creation of a non-blackbody radiator. The use of this type of emitter in a thermal recycling cavity is disclosed. In general, any thermal emitter which restricts the spectral range of emission may be used in this invention, including but not limited to layered materials, metal flakes in a matrix, polarization films, and surfaces with large thermal gradients. Alternately, from a theoretical standpoint, the restriction of the emission wavelength leads to a decrease in the uncertainty of the wavelength range of the surface. Since wavelength is inversely proportionate to time, decreasing the uncertainty of the wavelength range of a source can be used to decrease the uncertainty of energy being present at another surface within the optical system. So from both a practical and theoretical standpoint, non-blackbody radiators can be used to create enhancement of thermal sources. Restriction of wavelength, polarization, and temporal emission are all embodiments of this invention.

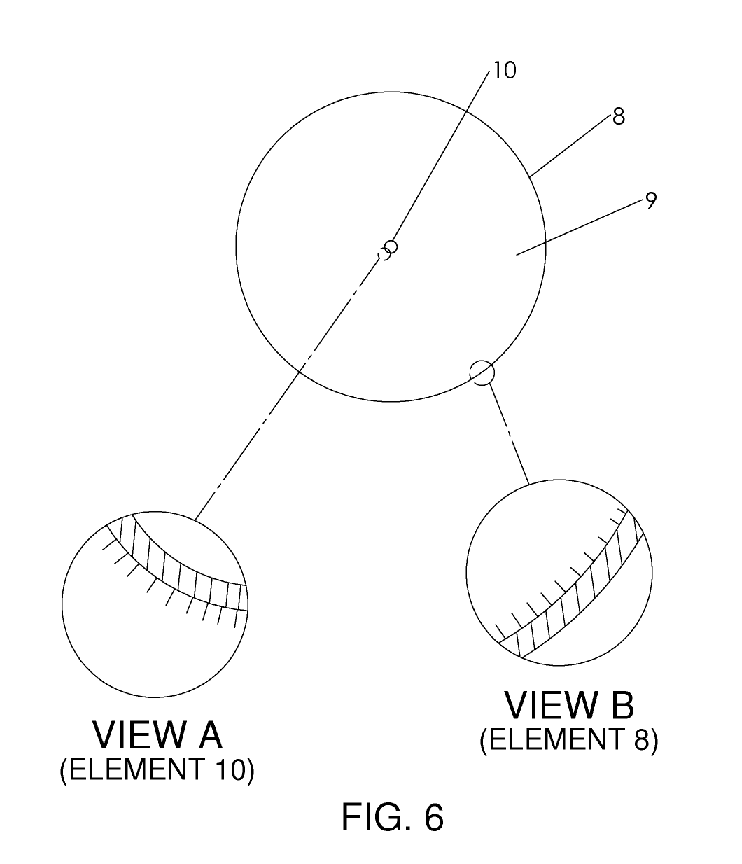

FIG. 6 depicts a basic thermal recycling cavity of the present invention. A larger area non-blackbody surface 8 is coupled to a smaller highly absorbing surface 10 via a low loss media 9. In these systems it is important that losses are minimized as such vacuum is a preferred low loss media 9. The use of photonic band gap structures for either non-blackbody surface 8 and/or highly absorbing surface 10 is a preferred embodiment. However, any means which modifies the absorptivity and emissivity relationship of either non-blackbody surface 8 and/or highly absorbing surface 10 can be used including, but not limited to, metal flakes in a matrix, surfaces with large thermal gradients, and layered materials. The intent is to create a substantial difference in the radiative characteristics of highly absorbing surface 10 and non-blackbody surface 8 such that localization of energy can occur. Spectral range, polarization state, and/or temporal changes can all be used to create substantially dissimilar radiative characteristics for surfaces 8 and 10. As an example, restricting emission to a specific polarization state using carbon nanowire radiators for surface 8 would enable enhancement energy at surface 10.

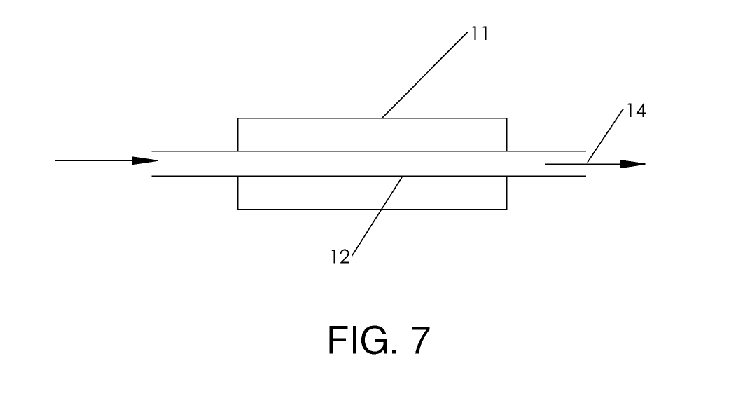

FIG. 7 depicts a thermal recycling cavity with an outer surface 11 and an inner surface 12 which exhibit substantially different radiative properties. In this embodiment, a input fluid 13 including, but not limited to, liquids, gases and solids are heated by inner surface 12 to a higher temperature such that exiting fluid 14 is hotter than input fluid 13. The selection of substantially different radiative properties and area ratios for outer surface 11 and inner surface 12 is determined by the ambient environment to which outer surface 11 is exposed and the desired temperature of inner surface 12. As an example, if heated air at 150 degrees C. from a geothermal source is used to define the ambient environment for outer surface 11 the radiative properties of both outer surface 11 and inner surface 12 might be different than if the ambient environment were determined by 60 degrees C. cooling water from nuclear reactor.

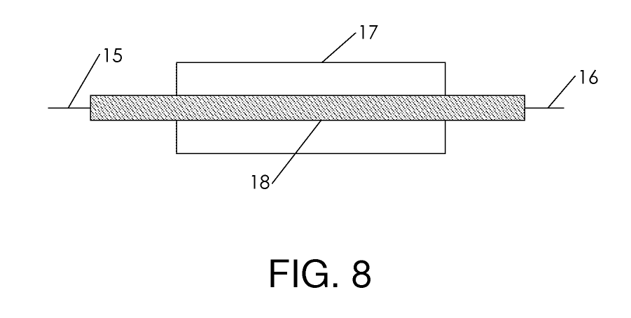

FIG. 8 depicts a thermal recycling cavity in which inner surface 18 is also a thermoelectric element which directly converts the temperature gradient created with thermal recycling cavity into electricity. Outer surface 17 again is designed to localize energy density on inner surface 18 but in this case the resulting temperature difference is used to create a temperature gradient across a thermoelectric element 18. Electrons would flow via contacts 15 and 16. Alternately contacts 15 and 16 may also be used as thermal connections for inner surface 18 to ambient environment to which outer surface 17 is exposed such that a temperature gradient is created within the thermoelectric element.

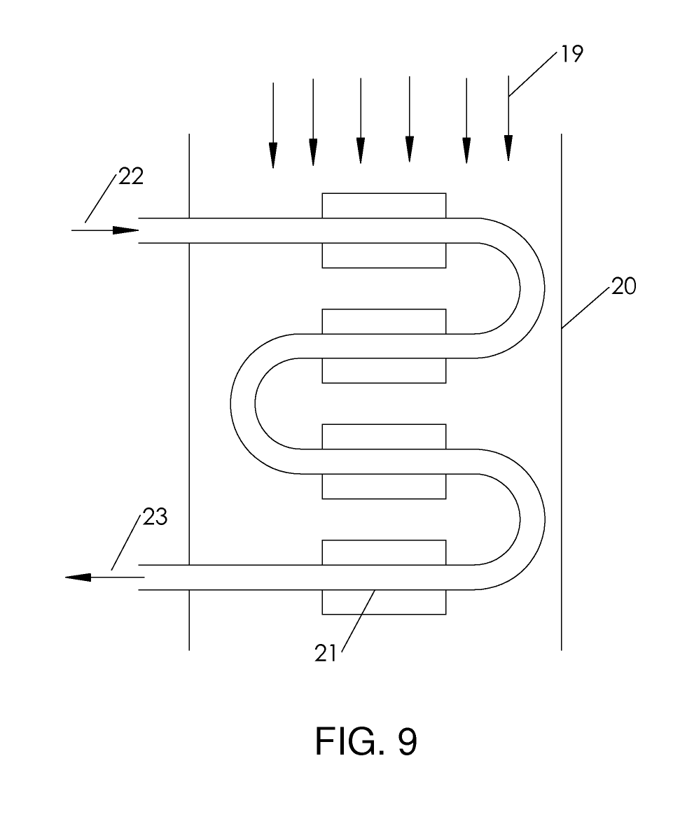

FIG. 9 depicts how a thermal recycling cavity 21 can be used within a plenum 20 containing a flowing media 19. In this embodiment, input fluid 22 experience multiple stages of enhancement from a single ambient environment. Each stage may or may not be the same thermal recycling cavity design depending on the desired state of output fluid 23.

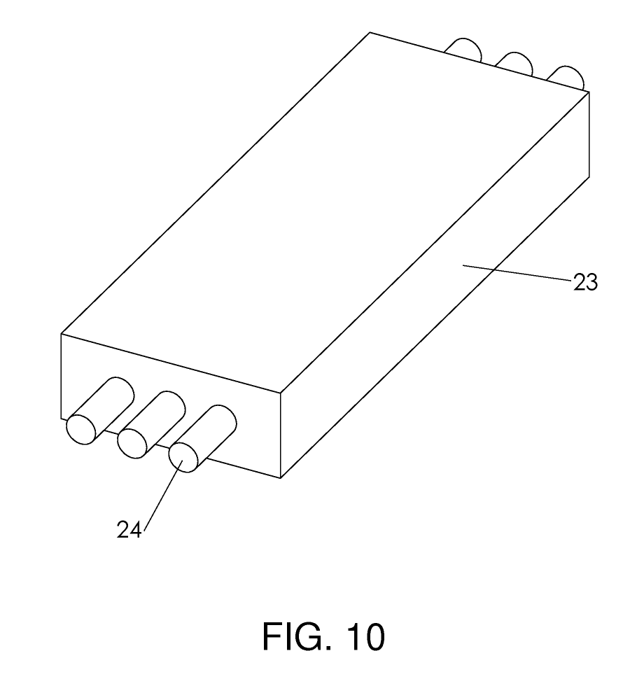

FIG. 10 depicts a micro thermal recycling cavity for mobile applications for the replacement of batteries. In this case outer surface 23 is exposed to body heat and room ambient temperature and inner surfaces 24 are thermoelectric elements which directly convert the generated temperature gradient into electricity. The use of thermal recycling sources to eliminate batteries is preferred embodiment of this invention.

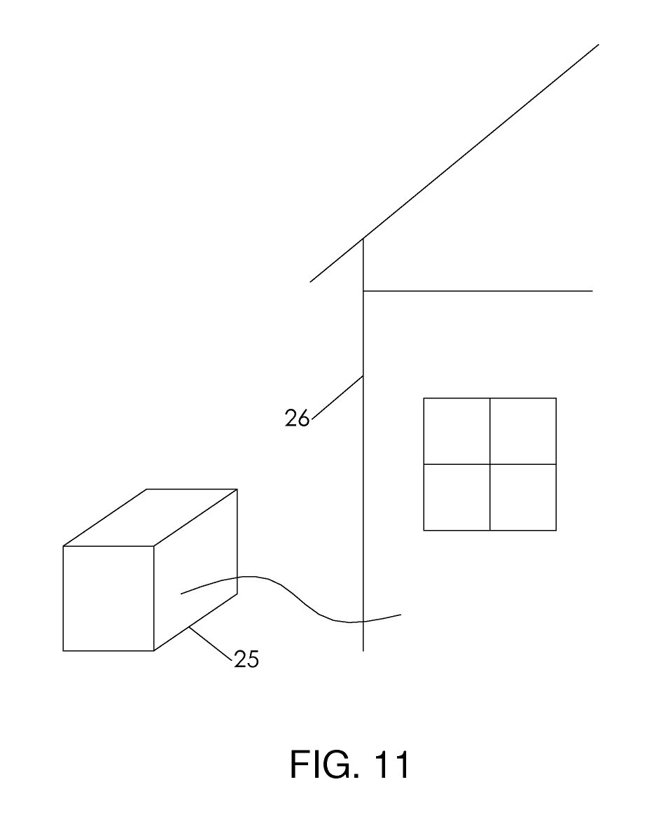

FIG. 11 depicts a distributed power source 25 for residential applications containing thermal recycling cavity sources. The use of thermal recycling sources to provide electricity and hot water 26 to residential applications is a preferred embodiment of this invention.

While the invention has been described with the inclusion of specific embodiments and examples, it is evident to those skilled in the art that many alternatives, modifications and variations will be evident in light of the foregoing descriptions.

Accordingly, the invention is intended to embrace all such alternatives, modifications and variations that fall within the spirit and scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. An article consisting of,
an outer radiator coupled to a heat source;
an inner radiator coupled substantially radiatively to said outer radiator via a low loss coupling means wherein, said outer radiator has substantially larger surface area than said inner radiator and said radiators have substantially different radiative properties and the inner radiator contains a means of extracting energy.

13. The article of claim 12 wherein said article powers a portable device.

14. The article of claim 12 wherein said heat source is coupled to the outside of said outer radiator and energy is extracted from said inner radiator to form a waste heat recovery system.

15. The article of claim 12 wherein said heat source is the ambient environment.

16. The article of claim 12 wherein said heat source consist of at least one of the following: geothermal, solar heating, waste heat, or chemical reaction.

17. The article of claim 12 wherein said article is used to heat water.

18. The article of claim 12 wherein said article is used as a distributed power source.

19. The article of claim 12 further comprising at least one thermoelectric element which directly converts the temperature gradient between said outer radiator and said inner radiator into electricity.
